(19) United States
(12) Patent Application Publication
(10) Pub. No.: US 2025/0247269 A1
(43) Pub. Date: Jul. 31, 2025

(54) A PORT FOR DAISY CHAIN TOPOLOGY

(71) Applicant: Honeywell International Inc., Charlotte, NC (US)

(72) Inventors: Zhi Yi Sun, Beijing (CN); Kaixuan Qin, Tianjin (CN); Hua Tang, Beijing (CN); Ke Wei Han, Tianjin (CN); Chao Chen, Beijing (CN); Jian Wang, Tianjin (CN); Yu Zhi Yan, Tianjin (CN)

(21) Appl. No.: 18/856,743

(22) PCT Filed: Apr. 14, 2022
(86) PCT No.: PCT/CN2022/086794

§ 371 Date: Oct. 14, 2024

(51) Int. Cl. H04L 12/40; G06F 13/42

(52) U.S. Cl. CPC H04L 12/40039; G06F 13/4247

(57) ABSTRACT

A system having, for example, data lines. In a case of any device that loses power, to keep communications, the data lines may be disconnected from, for instance, a physical layer transceiver, and at the same time, the lines may be connected to other lines to bypass the powered-off device. FETs and reed switches may be used for connection, disconnection and bypass functions.

The present application claims priority to PCT International Application No. PCT/CN2022/086794, filed on Apr. 14, 2022, entitled “A PORT FOR DAISY CHAIN TOPOLOGY”, which is incorporated herein by reference.

### BACKGROUND

The present disclosure pertains to daisy chain topology. The disclosure also pertains to remedying failures of one or more devices connected in the topology

### SUMMARY

The disclosure may have, for example, data lines. In the case of any device that loses power, to keep the communication, the data lines may be disconnected from, for instance, a physical layer transceiver, and at the same time, the lines may be connected to other lines to bypass issues with the powered-off device. FETs and reed switches may be used here for connection, disconnection and bypass functions.

### BRIEF DESCRIPTION OF DRAWING

FIG. 1 is a diagram may have, for example, data lines. In the case of any device that loses power, to keep the communications, the data lines may be disconnected from, for instance, a physical layer transceiver, and at the same time, the lines may be connected to other lines to bypass the powered-off device; and

FIG. 2 and FIG. 3 are diagrams for a port mechanism with reed switches that may be an alternative to the FETs for a T1L daisy chain topology.

### DESCRIPTION

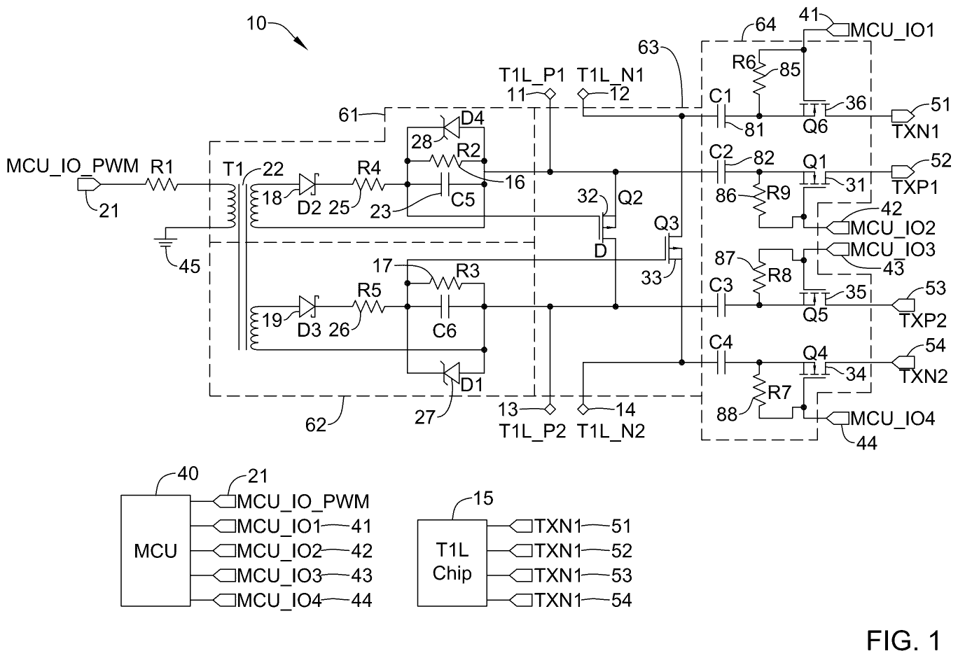

FIG. 1 is a diagram may have, for example, data lines. In the case of any device that loses power, to keep the communication, the data lines may be disconnected from, for instance, a physical layer transceiver, and at the same time, the lines should be connected to other lines to bypass the powered-off device. An electromagnetic or solid state relay may be applied to achieve the disconnection and bypass functions relative to issues with the powered-off device. However, due to the high price and big physical volume of each relay, this relay scheme may be costly and occupy a large printed circuit board (PCB) area. Using a relay may also lead to high power consumption as well. The present disclosure mitigates and eliminates these concerns.

A T1L port issue to be solved is indicated as in the following. A T1 circuit may be an Internet connection providing a high-speed T1 bandwidth delivered over fiber optic or copper phone lines. A T1L may be an Ethernet physical layer standard. In a T1L daisy chain topology 10, a device in topology 10 of FIG. 1 may have, for example, four data lines 11 (T1L_P1, 12 (T1L_N1), 13 (T1L_P2) and 14 (T1L_N2). In the case of any device that loses power, to keep the communication, the four data lines 11, 12, 13, and 14 should be disconnected from T1L PHY 15 (physical layer transceiver), and at the same time, line 11 should be connected to line 13, and line 12 should be connected to line 14 to bypass the powered-off device. An electromagnetic or solid state relay may be applied to achieve the disconnection and bypass function. However, due to the high price and big physical volume of each relay, this relay scheme may be costly and occupy a large printed circuit board (PCB) area. Using a relay may also lead to high power consumption as well.

As a feature in topology 10, FETs, for example, such as MOSFETs, may be used to realize an equivalent function. Components of similar circuits may be described herein in a parallel manner. Each circuit 61 and 62, may have a constant isolated DC voltage across a capacitor 23, 24 (C5/C6), respectively, generated by a fly back convertor to be used to drive a P-depletion FETs 32, 33 (Q2/Q3) of data line switching circuit 63, which avoids an impact of a common voltage difference, and the voltage between a FET gate and source can be kept relatively constant to ensure a full connection or disconnection. This scheme may reduce the costs/PCB area/power consumption, and increase the flexibility of the port control relative to the related art.

Device power detection circuits 61, 62 may be achieved as in the following. When the device is normally working, such as a microcontroller (MCU) having an input/output pulse width modulated (MCU_IO_PWM) at port 21, would output a PWM voltage wave to an inductive transformer 22 (T1). When the output voltage is high, transformer 22 would be charged. The energy stored in transformer 22 may be released to the secondary circuit to charge a capacitors 23, 24 by a current-limited resistor 25, 26 (R4/R5) during the output low voltage period. Diodes 18, 19 (D2/D3) may be connected in series between the secondary circuit of transformer 22 and a respective resistor 25, 26. Once the voltage across the capacitors 23, 24, reaches the switching voltage of a Zener diodes 27, 28 (D1/D4), the voltage on each capacitor 23, 24, may be kept at a constant voltage level. A 500k ohm resistor 16, 17 (R2/R3) may be connected in parallel with each capacitor 23, 24. A positive terminal of a capacitor 23, 24, may be connected to a gate of a P-depletion FET 32, 33, and the negative terminal of capacitor 23, 24 may be connected to a source of the P-depletion FETs 32, 33, respectively, which would keep the P-depletion FETs 32, 33 off.

An output voltage of MCU 40 on terminals 41, 42, 43, 44 (MCU_IO1/MCU_IO2/MCU_IO3/MCU_IO4) may be higher than the maximum voltage on the data lines, which will keep the N-enhanced FETs 36, 31, 35, 34 (Q6/Q1/Q5/Q4) open to allow a passage of signals at interface 64.

Lines 11, 12, 13 and 14 may be connected to capacitors 81 (C1), 82 (C2), 83 (C3) and 84 (C3), respectively. Capacitors 81, 82, 83 and 84 may be connected to 500 k ohm resistors 85 (R6), 86 (R9), 87 (R8) and 88 (R7), respectively. Resistors 85, 86, 87 and 88 may be connected to FETs 36, 31, 35, 34, respectively.

When the device is powered off, there would be no PWM output at port 21, which would lead to a stop of charging capacitor 23, 24. When the voltage on the capacitor 23, 24 gets to zero, the voltage on the gate of FET 32, 33 may be equal to the voltage on the source of FET 32, 33, which would keep FET 32, 33 open to connect lines 11 to 13 and 12 to 14. At the same time, the output voltage of signals from MCU terminals 41, 42, 43, 44 from MCU 40 is equal to the GND 45, which would turn off the FETs 31, 34, 35, 36 to disconnect the four data lines 11, 12, 13, 14 from T1L PHY 15 via connections of terminals 51, 52, 53, 54 (TXN1/TXP1/TXN2/TXP2). If any device needs to be detached from the network, a similar function may also be achieved by a software adjustment.

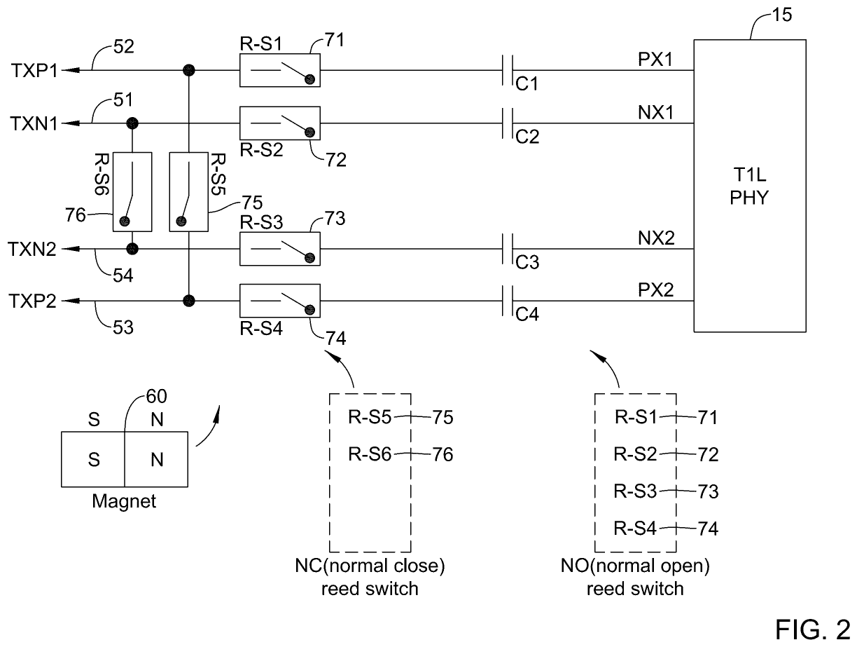

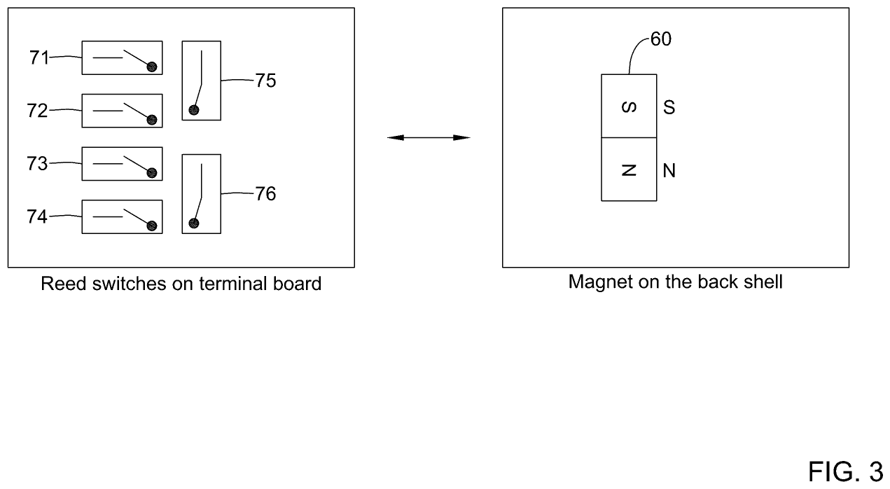

A T1L port mechanism with reed switches may be an alternative to the FETs for the T1L daisy chain topology. FIG. 2 and FIG. 3 may be noted. One may see that T1L is a communication way in IoT. In the mechanism, a reed switch may be used in the T1L port to perform the bypass function when any device is removed. By a proper mechanical approach, a reed switch can be applied on a T1L port with low cost and no power consumption. In the design, for example, six reed switches may be used in the T1L port with the reed switches placed on a terminal board. A magnet may be mounted on the back shell of a device to drive a reed switch. For example, four reed switches 71, 72, 73, 74 (R-S1/R-S2/R-S3/R-S4) on the data line connected to a line in series may be normal open mode (NO) and two other reed switches 75, 76 (R-S5/R-S6) are normal closed mode (NC). When a device is connected to the terminal board, a magnet 60 on the back shell may drive the NO reed switch to a close status and drive the NC reed switch to an open status, which can keep the device joined to the network. Once the device is removed, the magnetic driving force does not exist which can lead to the reeds having a switched status reversion. Reed switches 71, 72, 73, 74 may disconnect the link to PHY 15, and switch 75, 76 may connect P1/P2 and N1/N2 lines which can bypass the detached device and maintain the T1L Bus communication.

A related scheme might be used in a next generation building technologies control system. There may be an IoT with an IoT stack level of an edge—hardware device with embedded software that can be connected securely to the cloud via a wired or wireless connection. An electromagnetic or solid state relay may be applied to achieve the disconnection and bypass function. However, due to the high price and big size of relays, the usual relay scheme is costly and occupies a large printed circuit board (PCB) area. Also, using a relay may lead to high power consumption. As a feature in the present topology, FETs may be used to realize an equivalent function. One may use MOSFETs to substitute for the relays.

It is challenging to provide a proper drive voltage to drive the FET in a correct state considering the voltage fluctuation caused by different common GND voltage and surge voltage. The present circuit can provide a constant drive voltage between the gate and drain of the FET. With this design, one can achieve the bypass function with a FET. The IP bypass function may be performed on the external bus line. The bypass function may be performed in the internal port of local device (before the transformer).

Bypass on the external bus may avoid the degradation of the signal quality due to the influence of isolated transformer or isolated capacitor and the port local circuit such as the parasitic capacitive path.

A challenge by driving MOSFET directly on the external bus line is that it is difficult to design a proper drive voltage to drive the MOSFET in a correct state considering the voltage fluctuation caused by common voltage difference and surge voltage. Herein one may have a special circuit to provide a constant drive voltage between the gate and drain of MOSFET which can keep the MOSFET in a correct state.

The present approach may be for the replaceable device in the T1L daisy chain is to adopt a reed switch to achieve the function without any consumption and special controlling circuit. A feature is that one may use a magnet installed in the replaceable device to drive the reed switch on the terminal without any circuit, which is very suitable in the replaceable device.

To recap, a port assembly for a daisy chain topology may incorporate a converter configured to receive an input from a device, a first transistor or reed switching mechanism configured to receive an input from the converter and a plurality of data lines, and a second transistor or reed switching mechanism configured to accept a plurality of data lines and an input from the first transistor or reed switching mechanism. The converter may indicate a power status of the device to the first transistor or reed switching mechanism, the power status may indicate whether the device has power or no power. If the device has power, then signals on the data lines may be forwarded to the second transistor or reed switching mechanism to be configured for sending the signals on the data lines to the device.

If the device has no power, then the signals on the data lines may bypass the second transistor or reed switching mechanism and go to the device.

If an input to the converter is zero then the data on the lines may be bypassed by the second transistor or reed switching mechanism. If an input to the converter has a magnitude greater than zero, then the signals on the data lines may be forwarded to the second transistor or reed switching mechanism which in turn may be forwarded to the device.

The first transistor or reed switching mechanism may be configured with FET transistors.

The first transistor or reed switching mechanism may be configured with MOSFETs.

The first transistor or reed switching mechanism may be configured with reed switches.

The second s transistor or reed switching mechanism may be configured with reed switches.

The reed switches may be controlled by a magnet.

A system that achieves with FET disconnection, connection and bypass of data lines in an event of loss of power by a device, may incorporate a device power detection module, a bypass module connected to the device power detection module, and an interface module connected to the data line bypass module. The device power detection module may have an input for connection to a device voltage terminal. The bypass module may have an output that indicates the next action relative to data lines in the event of power-on status or power-off status. If the power-on status is indicated at the device power detection module, then the data lines may pass signals through the bypass detection module and the interface module via FET technology. If the power-off status is indicated at the device power detection module, then the data lines may bypass the interface module via FET technology.

The power-on status may provide a voltage to a transformer. Energy stored in the transformer by the voltage may go to a capacitor. The voltage on the capacitor may be kept at a constant magnitude.

The capacitor may have a positive terminal connected to a gate of a P-depletion FET and a negative terminal connected to a source of the P-depletion FET, which keep the P-depletion FET off, and prevent conduction of signals on data lines of the device to one another and permit the signals to have a voltage higher than the maximum voltage on the data lines which keep the one or more N-enhanced FETs open to allow a passage of signals from the data lines.

The device power-off status may provide no voltage to the transformer without charging the capacitor which in turn may get to zero with a voltage on a gate of the P-depletion FET which is equal to a voltage on a source of the P-depletion FET which may keep the P-depletion FET open to connect certain data lines.

An output voltage of signals from device terminals may be equal to a ground voltage resulting in turning off the N-enhanced FETs to disconnect the data lines from T1L PHY (physical layer transceiver). The device may be an MCU (microcomputer).

A port for signal routing topology may incorporate a first transistor or reed switch circuit configured to disconnect and connect to bypass a plurality of data lines in the event of a power off of a device and yet keep communication. The first transistor or reed switch circuit may incorporate a converter that provides a voltage indicative of a power off or power on status of the device. The voltage may ensure a connection or disconnection of the plurality of data lines.

The connection or disconnection of the plurality of data lines may be performed by one or more FET switches.

The connection or disconnection of the plurality of data lines may be performed by one or more reed switches.

The port may further incorporate a second transistor or reed switch circuit having a transistor connected to each of the plurality of data lines. A voltage signal to each transistor may indicate the power-on status of the device. Each data line of the plurality of data lines may be connected to each transistor for communication with the device.

The first transistor or reed switch circuit may further incorporate a transistor or reed switch connected in series with each data line of the plurality of data lines. Each transistor or reed switch may open or close a connection between each data line and each transistor or reed switch for communication with the device.

Each transistor may be a field effect transistor (FET).

Each transistor may be replaced with a reed switch. Each reed switch may have a closed position or alternatively an open position, which can be selected with a magnet.

In the present specification, some of the matter may be of a hypothetical or prophetic nature although stated in another manner or tense.

Although the present system and/or approach has been described with respect to at least one illustrative example, many variations and modifications will become apparent to those skilled in the art upon reading the specification. It is therefore the intention that the appended claims be interpreted as broadly as possible in view of the related art to include all such variations and modifications.

What is claimed is:

1. A port assembly for a daisy chain topology comprising:
a converter configured to receive an input from a device;
a first transistor or reed switching mechanism configured to receive an input from the converter and a plurality of data lines; and
a second transistor or reed switching mechanism configured to accept a plurality of data lines and an input from the first transistor or reed switching mechanism; and
wherein:
the converter indicates a power status of the device to the first transistor or reed switching mechanism, the power status indicates whether the device has power or no power; and
if the device has power, then signals on the data lines are forwarded to the second transistor or reed switching mechanism to be configured for sending the signals on the data lines to the device.

2. The assembly of claim 1, wherein if the device has no power, then the signals on the data lines bypass the second transistor or reed switching mechanism and go to the device.

3. The assembly of claim 1, wherein:
if an input to the converter is zero then the data on the lines are bypassed by the second transistor or reed switching mechanism; and
if an input to the converter has a magnitude greater than zero, then the signals on the data lines are forwarded to the second transistor or reed switching mechanism which in turn are forwarded to the device.

4. The assembly of claim 1, wherein the first transistor or reed switching mechanism is configured with FET transistors.

5. The assembly of claim 4, wherein the first transistor or reed switching mechanism is configured with MOSFETs.

6. The assembly of claim 1, wherein the first transistor or reed switching mechanism is configured with reed switches.

7. The assembly of claim 6, wherein the second s transistor or reed switching mechanism is configured with reed switches.

8. The assembly of claim 7, wherein the reed switches are controlled by a magnet.

9. A system that achieves with FET disconnection, connection and bypass of data lines in an event of loss of power by a device, comprising:
a device power detection module;
a bypass module connected to the device power detection module; and
an interface module connected to the data line bypass module; and
wherein:
the device power detection module has an input for connection to a device voltage terminal;
the bypass module has an output that indicates the next action relative to data lines in the event of power-on status or power-off status;
if the power-on status is indicated at the device power detection module, then the data lines can pass signals through the bypass detection module and the interface module via FET technology; and
if the power-off status is indicated at the device power detection module, then the data lines can bypass the interface module via FET technology.

10. The system of claim 9, wherein:
the power-on status can provide a voltage to a transformer;
energy stored in the transformer by the voltage goes to a capacitor; and
the voltage on the capacitor is kept at a constant magnitude.

11. The system of claim 10, wherein the capacitor has a positive terminal connected to a gate of a P-depletion FET and a negative terminal connected to a source of the P-depletion FET, which keep the P-depletion FET off, and prevent conduction of signals on data lines of the device to one another and permit the signals to have a voltage higher than the maximum voltage on the data lines, which keep the one or more N-enhanced FETs open to allow a passage of signals from the data lines.

12. The system of claim 11, wherein the device power-off status provides no voltage to the transformer without charging the capacitor which in turn gets to zero with a voltage on a gate of the P-depletion FET which is equal to a voltage on a source of the P-depletion FET which keeps the P-depletion FET open to connect certain data lines.

13. The system of claim 12, wherein:
an output voltage of signals from device terminals are equal to a ground voltage resulting in turning off the N-enhanced FETs to disconnect the data lines from T1L PHY (physical layer transceiver); and
the device is an MCU (microcomputer).

14. A port for signal routing topology comprising:
a first transistor or reed switch circuit configured to disconnect and connect to bypass a plurality of data lines in the event of a power off of a device and yet keep communication; and
wherein:
the first transistor or reed switch circuit comprises a converter that provides a voltage indicative of a power off or power on status of the device; and
the voltage ensures a connection or disconnection of the plurality of data lines.

15. The port of claim 14, wherein the connection or disconnection of the plurality of data lines is performed by one or more FET switches.

16. The port of claim 14, wherein the connection or disconnection of the plurality of data lines is performed by one or more reed switches.

17. The port of claim 14, further comprising:
a second transistor or reed switch circuit having a transistor connected to each of the plurality of data lines; and
wherein:
a voltage signal to each transistor indicates the power on status of the device; and
each data line of the plurality of data lines is connected to each transistor for communication with the device.

18. The port of claim 17, wherein the first transistor or reed switch circuit further comprises:
a transistor or reed switch connected in series with each data line of the plurality of data lines; and
wherein each transistor or reed switch can open or close a connection between each data line and each transistor or reed switch for communication with the device.

19. The port of claim 17, wherein each transistor is a field effect transistor (FET).

20. The port of claim 17, wherein:
each transistor is replaced with a reed switch; and
each reed switch has a closed position or alternatively an open position, which can be selected with a magnet.
